(19) United States
(12) Patent Application Publication
(10) Pub. No.: US 2008/0045689 A1
(43) Pub. Date: Feb. 21, 2008

(54) Method for Producing Highly-Branched Polyester Amides

(75) Inventors: Jean-Francois Stumbe, Strasbourg (FR); Bernd Bruchmann, Freinsheim (DE)

Correspondence Address: CONNOLLY BOVE LODGE & HUTZ, LLP, P O BOX 2207, WILMINGTON, DE, 19899, US

(73) Assignee: BASF Aktiengesellschaft Patents, Trademarks and Licenses, Ludwigshafen (DE)

(21) Appl. No.: 11/659,747

(22) PCT Filed: Aug. 2, 2005
(86) PCT No.: PCT/EP05/08338

§ 371 Date: Feb. 8, 2007

(30) Foreign Application Priority Data
Aug. 11, 2004 (DE) 10 2004 039 102.5

(51) Int. Cl. C08G 83/00; C08G 69/44

(52) U.S. Cl. 528/335

(57) ABSTRACT

Processes comprising: (a) providing a carboxylic acid having at least two carboxy groups, and an amino alcohol having at least one amino group and at least two hydroxy groups; and (b) reacting the carboxylic acid and the amino alcohol in a molar ratio selected from ratio values of; (i) 1.1:1 to 1.95:1, to form a highly branched or hyperbranched polyesteramide; and (ii) 2:1 to 10:1, to form a prepolymer, and reacting the prepolymer with a monomer having at least one functional group to form a highly branched or hyperbranched polyesteramide; polyesteramides thus formed; and objects made from such polyesteramides.

The invention relates to a process for preparation of highly branched or hyperbranched polyesteramides which comprises reacting a carboxylic acid having at least two carboxy groups with an amino alcohol which has at least one amino group and at least two hydroxy groups, where
a) the carboxylic acid and the amino alcohol are reacted using a molar ratio of from 1.1:1 to 1.95:1 to give the final product immediately, or
b) the carboxylic acid and the amino alcohol are first reacted using a molar ratio of from 2:1 to 10:1 to give a prepolymer, and then the prepolymer is reacted with a monomer M which has at least one functional group.

The invention further relates to the polyesteramides obtainable by the process, to their use for the production of moldings, of foils, of fibers, or of foams, and also to the moldings, foils, fibers, and foams composed of the polyesteramides.

Dendrimers can be prepared starting from one central molecule via controlled stepwise linkage of, in each case, two or more di- or polyfunctional monomers to each previously bonded monomer. Each linkage step here exponentially increases the number of monomer end groups, and this gives polymers with spherical dendritic structures, the branches of which comprise exactly the same number of monomer units. This “perfect” structure provides advantageous polymer properties, and by way of example surprisingly low viscosity is found, as is high reactivity, due to the large number of functional groups on the surface of the sphere. However, the preparation process is complicated by the fact that protective groups have to be introduced and in turn removed again during each linkage step, and cleaning operations are required, the result being that it is usual for dendritic polymers to be prepared only on a laboratory scale. However, highly branched or hyperbranched polymers can be prepared using industrial processes. They also have linear polymer chains and uneven polymer branches alongside perfect dendritic structures, but this does not substantially impair the properties of the polymer when comparison is made with the perfect dendrimers. Hyperbranched polymers can be prepared via two synthetic routes known as the AB₂ and A₂+B₃ strategies. A and B here represent functional groups in a molecule. In the AB₂ route, a trifunctional monomer having one functionality A and two functional groups B is reacted to give a hyperbranched polymer. In the A₂+B₃ synthesis, a monomer having two functional groups A is first reacted with a monomer having three functional groups B. The product in the ideal case is a 1:1 adduct having only one remaining functional group A and two functional groups B, known as a “pseudo-AB₂ molecule, which then reacts further to give a hyperbranched polymer.

The present invention relates to the A₂+B₃ synthesis in which an at least difunctional carboxylic acid is reacted with an at least trifunctional amino alcohol.

EP-A 1 295 919 mentions preparation of, inter alia, polyesteramides from monomer pairs Aₛ and Bₜ, where s≧2 and t≧3. The polyesteramide used comprises a commercially available product; no further information is given relating to the preparation of the polyesteramides, in particular relating to molar ratios. The triamine:dicarboxylic acid molar ratio used in the examples for the preparation of the polyamides likewise mentioned in the specification is 2:1, i.e. an excess of the trifunctional monomer.

WO 00/56804 describes the preparation of polymers with esteralkylamide-acid groups via reaction of an alkanolamine with a molar excess of a cyclic anhydride, the ratio of anhydride:alkanolamine equivalents being from 2.0:1 to 3.0:1 The excess of anhydride is therefore at least 2-fold. Instead of the anhydride it is also possible to use a monoester, anhydride, or thioester of a dicarboxylic acid, the carboxylic acid compound:alkanolamine ratio again being from 2.0:1 to 3.0:1.

WO 99/16810 describes the preparation of polyesteramides containing hydroxyalkylamide groups, via polycondensation of mono- or bishydroxyalkylamides of a dicarboxylic acid, or via reaction of a cyclic anhydride with an alkanolamine. The ratio of anhydride:alkanolamine equivalents is from 1.0:1.0 to 1.0:1.8, meaning that the anhydride is the substoichiometric component.

Muscat et al., in Topics in Current Chemistry 2001, volume 212, pp. 41-80, disclose hyperbranched polyesteramides. On pp. 54-57, their preparation is described via reaction of diisopropanolamine (DIPA) with an excess of cyclic anhydrides or with an excess of dicarboxylic acids, e.g. adipic acid, but the polyesteramide is not obtained when the molar adipic acid:DIPA ratio is 2.3:1, but only when the ratio is 3.2:1.

The processes of the prior art are either inconvenient because they require more than one reaction step, or use “exotic” and therefore expensive monomers. In addition, the resultant branched polymers have a structure which has insufficient branching, and the polymers therefore have inadequate properties.

It was an object to eliminate the disadvantages described. In particular, a process should be provided permitting preparation of hyperbranched polyesteramides in a simple manner, ideally in a one-pot reaction.

The process should start from commercially available, inexpensive monomers.

Furthermore, the resultant polyesteramides should feature an improved structure, and in particular feature a more ideal branching structure.

Accordingly, the process defined at the outset has been found, as have the polymers obtainable thereby. The use mentioned has moreover been found, as have the moldings, foils, fibers, and foams mentioned. Preferred embodiments of the invention are given in the subclaims.

The process starts from a carboxylic acid having at least two carboxy groups (dicarboxylic acid, tricarboxylic acid, or carboxylic acid of higher functionality) and from an amino alcohol (alkanolamine) having at least one amino group and having two hydroxy groups.

Suitable carboxylic acids usually have from 2 to 4, in particular 2 or 3, carboxy groups, and have an alkyl, aryl, or arylalkyl radical having from 1 to 30 carbon atoms.

Examples of dicarboxylic acids which may be used are: oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and also cis- and trans-cyclopentane-1,3-dicarboxylic acid, and the dicarboxylic acids here may have substitution by one or more radicals selected from:

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, or n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl,

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl and 2-naphthyl, particularly preferably phenyl.

Examples which may be mentioned of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, and 3,3-dimethylglutaric acid.

Other suitable compounds are ethylenically unsaturated dicarboxylic acids, such as maleic acid and fumaric acid, and also aromatic dicarboxylic acids, such as phthalic acid, isophthalic acid, or terephthalic acid.

Examples of suitable tricarboxylic acids or tetracarboxylic acids are trimesic acid, trimellitic acid, pyromellitic acid, butanetricarboxylic acid, naphthalenetricarboxylic acid, and cyclohexane-1,3,5-tricarboxylic acid.

It is also possible to use mixtures of two or more of the abovementioned carboxylic acids. The carboxylic acids may either be used as they stand or in the form of derivatives. These derivatives are in particular
the anhydrides of the carboxylic acids mentioned, and specifically in monomeric or else polymeric form;
the esters of the carboxylic acids mentioned, e.g.
   dialkyl esters, preferably dimethyl esters or the corresponding mono- or diethyl esters, and also the dialkyl esters derived from higher alcohols, such as n-propanol, isopropanol, n-butanol, isobutanol, tert-butanol, n-pentanol, n-hexanol,
   divinyl esters, and also
   mixed esters, preferably methyl ethyl esters.

It is also possible to use a mixture composed of a carboxylic acid and of one or more of its derivatives, or a mixture of two or more different derivatives of one or more dicarboxylic acids.

The carboxylic acid used particularly preferably comprises succinic acid, glutaric acid, adipic acid, phthalic acid, isophthalic acid, terephthalic acid, or dimethyl esters thereof. Adipic acid is very particularly preferred.

Preferred suitable amino alcohols (alkanolamines) having at least one amino group and at least two hydroxy groups are dialkanolamines and trialkanolamines. Examples of dialkanolamines which may be used are those of the formula 1 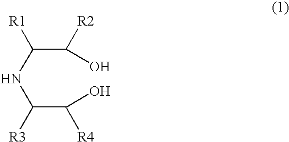
where R1, R2, R3, and R4, independently of one another, are hydrogen, C₁₋₆-alkyl, C₃₋₁₂-cycloalkyl or C₆₋₁₄-aryl (inc. arylalkyl).

Examples of suitable dialkanolamines are diethanolamine, diisopropanolamine, 2-amino-1,3-propanediol, 3-amino-1,2-propanediol, 2-amino-1,3-propanediol, diisobutanolamine, bis(2-hydroxy-1-butyl)amine, diisopropanolamine, bis(2-hydroxy-1-propyl)amine, and dicyclohexanolamine.

Suitable trialkanolamines are those of the formula 2 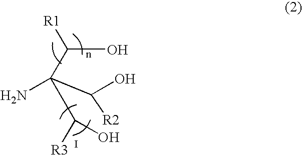
where R1, R2, and R3 are as defined for formula 1, and 1, m, and n, independently of one another, are whole numbers from 1 to 12. By way of example, tris(hydroxymethyl)aminomethane is suitable.

The amino alcohol used preferably comprises diethanolamine (DEA).

One preferred embodiment of the inventive process is one wherein the carboxylic acid used comprises a dicarboxylic acid and the amino alcohol used comprises an alcohol having one amino group and two hydroxy groups.

It is also possible to use a mixture of two or more carboxylic acids or carboxylic acid derivatives, or a mixture of two or more amino alcohols. The functionality here of the various carboxylic acids and, respectively, amino alcohols may be identical or different.

The reactivity of the carboxy groups of the carboxylic acid may be identical or different. Equally, the reactivity of the functional groups of the amino alcohol (amino groups and hydroxy groups) may be identical or different.

The inventive reaction may be carried out in one stage (variant a)) or in two stages (variant b)). In the single-stage variant a), the carboxylic acid and the amino alcohol are reacted using a molar ratio of from 1.1:1 to 1.95:1 to give the final product immediately. This differs from the WO 00/55804 mentioned, in which the ratio anhydride:alkanolamine is at least 2.0:1.

The inventive molar carboxylic acid:amino alcohol ratio in variant a) is preferably from 1.2:1 to 1.5:1.

In the case of the two-stage variant b), the carboxylic acid and the amino alcohol are reacted in the first stage using a molar ratio of from 2:1 to 10:1 to give a prepolymer. In the second stage, the prepolymer is then reacted with a monomer M, which has at least one functional group.

The inventive molar carboxylic acid:amino alcohol ratio in variant b) is preferably from 2.5:1 to 10:1, in particular from 2.7:1 to 5:1, and particularly preferably from 2.9:1 to 3.5:1.

The product of the first stage comprises a polyesteramide prepolymer with a low relatively molecular weight. Because there is a large excess of carboxylic acid in the first stage, the prepolymer has free, unreacted carboxy end groups, which then react in the second stage with the at least monofunctional monomer M to give the final product, the relatively high-molecular-weight polyesteramide. It is likely that the monomer M acts as an end-modifier.

The monomers M have preferably been selected from alcohols, amines, and amino alcohols (alkanolamines).

Suitable alcohols are monoalcohols, dialcohols (diols), and higher alcohols (e.g. triols or polyols). The monoalcohols M usually have alkyl radicals, aryl radicals, or arylalkyl radicals having from 1 to 30 carbon atoms, preferably from 3 to 20 carbon atoms. Examples of suitable monoalcohols are n-propanol, isopropanol, n-butanol, isobutanol, tert-butanol, n-pentanol, n-hexanol, 2-ethylhexanol, lauryl alcohol, stearyl alcohol, 4-tert-butylcyclohexanol, 3,3,5-trimethylcyclohexane, 2-methyl-3-phenylpropan-1-ol, and phenylglycol.

Examples of suitable diols M are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol, and derivatives, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H, or polypropylene glycols HO(CH[CH₃]CH₂O)ₙ—H, or a mixture of two or more representatives of the abovementioned compounds, where n is a whole number and n≧4. One, or else both, of the hydroxy groups in the abovementioned diols may also have been replaced by SH groups. Preference is given to ethylene glycol, propane-1,2-diol, and also diethylene glycol, triethylene glycol, dipropylene glycol, and tripropylene glycol.

Examples of polyols M which may be used are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane, or ditrimethylolpropane, trimethylolethane, pentaerythritol, or dipentaerythritol; sugar alcohols, such as mesoerythritol, threitol, sorbitol, mannitol, or a mixture of the abovementioned at least trifunctional alcohols. It is preferable to use glycerol, trimethylolpropane, trimethylolethane, or pentaerythritol.

Other polyols M also suitable are: oligoglycerols whose degree of polymerization is, for example, from 2 to 50, preferably from 2 to 7; ethoxylated glycerols with molar masses of from 100 to 1000 g/mol (e.g. Lupranol® from BASF); ethoxylated trimethylolpropane having from 0.1 to 10, preferably from 2.5 to 4.6, ethylene oxide units per hydroxy group; ethoxylated pentaerythritol having from 0.1 to 10, preferably from 0.75 to 3.75, ethylene oxide units per hydroxy group; or star-shaped, preferably water-soluble polyols having at least three polymer branches composed of polypropylene oxide-polyethylene oxide block copolymers (PPO-block-PEO).

Amines M used comprise monoamines, diamines, triamines, or higher-functionality amines (polyamines). The monoamines M usually have alkyl radicals, aryl radicals, or arylalkyl radicals having from 1 to 30 carbon atoms; examples of suitable monoamines are primary amines, e.g. monoalkylamines, and secondary amines, e.g. dialkylamines. Examples of suitable primary monoamines are butylamine, cyclohexylamine, 2-methylcyclohexylamine, 3-methylcyclohexylamine, 4-methylcyclohexylamine, benzylamine, tetrahydrofurfurylamine, and furfurylamine. Examples of secondary monoamines which may be used are diethylamine, dibutylamine, di-n-propylamine, and N-methylbenzylamine.

Examples of diamines M which may be used are those of the formula R¹—NH—R²—NH—R³, where R¹, R², and R³, independently of one another, are hydrogen or an alkyl, aryl, or arylalkyl radical having from 1 to 20 carbon atoms. The alkyl radical may be linear or in particular for R² may also be cyclic.

Examples of suitable diamines M are ethylenediamine, the propylenediamines (1,2-diaminopropane and 1,3-diaminopropane), N-methylethylenediamine, piperazine, tetramethylenediamine (1,4-diaminobutane), N,N′-dimethylethylenediamine, N-ethylethylenediamine, 1,5-diaminopentane, 1,3-diamino-2,2-diethylpropane, 1,3-bis(methylamino)propane, hexamethylenediamine (1,6-diaminohexane), 1,5-diamino-2-methylpentane, 3-(propylamino)propylamine, N,N′-bis(3-amino-propyl)piperazine, N, N′-bis(3-aminopropyl)piperazine, and isophoronediamine (IPDA).

Examples of suitable triamines, tetramines, or higher-functionality amines M are tris(2-aminoethyl)amine, tris(2-aminopropyl)amine, diethylenetriamine (DETA), triethylenetetramine (TETA), tetraethylenepentamine (TEPA), isopropylenetriamine, dipropylenetriamine, and N,N′-bis(3-aminopropylethylenediamine). Aminobenzylamines and aminohydrazides having 2 or more amino groups are likewise suitable.

Amino alcohols (alkanolamines) which may be used as monomers M have been mentioned at an earlier stage above. Others also suitable are other monoalkanolamines and dialkanolamines. Examples of these monoalkanolamines are ethanolamine (or monoethanolamine, MEA), isopropanolamine, mono-sec-butanolamine, 2-amino-2-methyl-1-propanol, tris(hydroxymethyl)aminomethane, 3-amino-1,2-propanediol, 1-amino-1-deoxy-D-sorbitol, and 2-amino-2-ethyl-1,3-propanediol. Examples of suitable dialkanolamines are diethanolamine (DEA), diisopropanolamine, and di-sec-butanolamine.

It is also possible to use a mixture of the monomers M mentioned, for example a mixture of mono- and difunctional monomers M.

The amount of the monomer M depends, inter alia, on the number of carboxy end groups in the prepolymer. By way of example, this carboxy group content of the prepolymer may be determined via titration to give the acid number to DIN 53402-2. It is usual to use from 0.6 to 2.5 mol, preferably from 0.7 to 1.7 mol, and in particular from 0.7 to 1.5 mol, of monomer M per mole of carboxy end groups. Examples of methods of adding the monomer M are all at once, batchwise in two or more portions, or continuously, e.g. following a linear, rising, falling, or step function.

The two stages of variant b) can be carried out in a simple manner in the same reactor; there is no requirement for isolation of the prepolymer or for introduction and, in turn, removal of protective groups. Of course it is also possible to use another reactor for the second stage.

In variant b), it is also possible to execute the first stage, reaction of carboxylic acid and amino alcohol, or else the second stage, reaction of the prepolymer with the monomer M, in two or more substages, thus giving a total of three or more stages.

The two-stage reaction b) permits preparation of hyperbranched polyesteramides with relatively high molecular weights. Variation of the molar ratios here can give polymers which have defined terminal monomer units (end groups of the branches of the polymers).

The two-stage reaction can moreover prepare polymers with a relatively high degree of branching (DB), because the prepolymer has a very high degree of branching. The degree of branching is defined as

$$DB = \frac{T + Z}{T + Z + L}$$

where T is the number of terminal monomer units, Z is the number of branched monomer units, and L is the number of linear monomer units.

The degree of branching DB of the polyesteramides obtained via single-stage reaction a) is usually from 0.2 to 0.6. The degree of branching DB in the polyesteramides obtained via two-stage reaction b) is usually from 0.3 to 0.8, preferably from 0.4 to 0.7, and in particular from 0.45 to 0.6.

Irrespective of whether variant a) or variant b) is used in carrying out the process, the reaction is preferably terminated, e.g. by permitting the mixture to cool, prior to reaching the gel point of the polymer (the juncture at which crosslinking reactions form insoluble gel particles, see, for example, Flory, Principles of Polymer Chemistry, Cornell University Press, 1953, pp. 387-398). It is often possible to use the sudden rise in viscosity of the reaction mixture to discern the juncture at which the gel point has been reached.

The inventive process can also prepare functionalized polyesteramides. For this, concomitant use is made of comonomers C, and these may be added prior to, during, or after the reaction of carboxylic acid, amino alcohol, and, if appropriate, monomer M. This gives a polymer chemically modified by the comonomer units and their functional groups.

One preferred embodiment of the process is therefore one wherein, prior to, during, or after the reaction of carboxylic acid, amino alcohol and, if appropriate, monomer M, concomitant use is made of a comonomer C, giving a modified polyesteramide. The comonomer may comprise one, two, or more than two functional groups.

Examples of suitable comonomers C are saturated or unsaturated monocarboxylic acids, or else fatty acids, and their anhydrides or esters. Examples of suitable acids are acetic acid, propionic acid, butyric acid, valeric acid, isobutyric acid, trimethylacetic acid, caproic acid, caprylic acid, heptanoic acid, capric acid, pelargonic acid, lauric acid, myristic acid, palmitic acid, montanic acid, stearic acid, isostearic acid, nonanoic acid, 2-ethylhexanoic acid, benzoic acid, and unsaturated monocarboxylic acids, such as methacrylic acid, and also the anhydrides and esters of the monocarboxylic acids mentioned.

Examples of suitable unsaturated fatty acids C are oleic acid, ricinoleic acid, linoleic acid, linolenic acid, erucic acid, and fatty acids derived from soy, linseed, castor oil, and sunflower. Particularly suitable carboxylic esters C are methyl methacrylate, hydroxyethyl methacrylate, and hydroxypropyl methacrylate.

Other comonomers C which may be used are alcohols, and also fatty alcohols, e.g. glycerol monolaurate, glycerol monostearate, ethylene glycol monomethyl ether, the polyethylene monomethyl ethers, benzyl alcohol, 1-dodecanol, 1-tetradecanol, 1-hexadecanol, and unsaturated fatty alcohols.

Other suitable comonomers C are acrylates, in particular alkyl acrylates, such as n-butyl acrylate, isobutyl acrylate, tert-butyl acrylate, lauryl acrylate, stearyl acrylate, or hydroxyalkyl acrylates, such as hydroxyethyl acrylate, hydroxypropyl acrylate, and the hydroxybutyl acrylates. The acrylates may be introduced in a particularly simple manner into the polymer via Michael addition at the amino groups of the hyperbranched polyesteramide.

Other comonomers which may be used are the abovementioned monofunctional or higher-functionality alcohols (among which are diols and polyols), amines (among which are diamines and triamines), and amino alcohols (alkanolamines). Diethanolamine is a particularly preferred comonomer C.

The amount of the comonomers C depends in the usual way on the extent to which the polymer is to be modified. The amount of the comonomers C is generally from 0.5 to 40% by weight, preferably from 1 to 35% by weight, based on the entirety of the amino alcohol and carboxylic acid monomers used.

The number of free OH groups in (hydroxyl number of) the final polyesteramide product is generally from 50 to 500, preferably from 70 to 450, mg KOH per gram of polymer, and can be determined, by way of example, via titration to DIN 53240-2.

The number of free COOH groups in (acid number of) the final polyesteramide product is generally from 0 to 400, preferably from 0 to 200, mg KOH per gram of polymer, and can likewise be determined via titration to DIN 53240-2.

The following comments relate to the reaction conditions:

The reaction of the carboxylic acid with the amino alcohol generally takes place at an elevated temperature, for example at from 80 to 250° C., in particular at from 90 to 220° C., and particularly preferably at from 95 to 180° C. If for purposes of modification the polymer is reacted with comonomers C and catalysts are used for this purpose (see a later stage below), the reaction temperature may be adapted to take account of the catalyst used, operations being generally carried out at from 90 to 200° C., preferably from 100 to 190° C., and in particular from 110 to 180° C.

Operations are preferably carried out under an inert gas, e.g. nitrogen, or in vacuo, in the presence or absence of a solvent, such as 1,4-dioxane, dimethylformamide (DMF), or dimethylacetamide (DMAC). However, there is no requirement to use a solvent; by way of example, the carboxylic acid may be mixed with the amino alcohol and—if appropriate in the presence of a catalyst—reacted at an elevated temperature. The water of reaction formed in the course of the polymerization (polycondensation) process is, by way of example, drawn off in vacuo or removed via azeotropic distillation, using suitable solvents, such as toluene.

The end of the reaction of carboxylic acid and amino alcohol can often be discerned from a sudden rapid rise in the viscosity of the reaction mixture. When the viscosity begins to rise, the reaction may be terminated, for example by cooling. A specimen of the mixture may then be used to determine the number of carboxy groups in the (pre)polymer, for example via titration to give the acid number to DIN 53402-2, and then, if appropriate, the monomer M and/or comonomer C may be added and reacted.

The pressure is generally not critical and, by way of example, is from 1 mbar to 100 bar absolute. If no solvent is used, the water of reaction can be removed in a simple manner by operating in vacuo, e.g. at from 1 to 500 mbar absolute.

The reaction time is usually from 5 minutes to 48 hours, preferably from 30 min to 24 hours, and particularly preferably from 1 hour to 10 hours.

As mentioned, the comonomers C mentioned may be added prior to, during, or after the polymerization process, in order to achieve chemical modification of the hyperbranched polyesteramide.

The inventive process may make concomitant use of a catalyst which catalyzes the reaction of the carboxylic acid with the amino alcohol (esterification), and/or, in the case of a two-stage reaction b), catalyzes the reaction with the monomer M and also/or else the reaction with the comonomer C (modification). Depending on whether the intention is to catalyze the esterification, the reaction with monomer M, or the modification with comonomer C, the catalyst may be added at the very start, or not until a later juncture.

Suitable catalysts are acidic, preferably inorganic catalysts, organometallic catalysts, or enzymes.

Examples of acidic inorganic catalysts which may be mentioned are sulfuric acid, phosphoric acid, phosphonic acid, hypophosphorous acid, aluminum sulfate hydrate, alum, acidic silica gel (pH≦6, in particular ≦5), and acidic aluminum oxide. Other examples of acidic inorganic catalysts which may be used are aluminum compounds of the general formula Al(OR)₃ and titanates of the general formula Ti(OR)₄, where each of the radicals R may be identical or different and these have been selected independently of one another from:

C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, or n-decyl; and also C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl. Each of the radicals R in Al(OR)₃ or Ti(OR)₄ is preferably identical and selected from isopropyl and 2-ethylhexyl.

Examples of preferred acidic organometallic catalysts are those selected from dialkyltin oxides R₂SnO, where R is as defined above. One particularly preferred representative of acidic organometallic catalysts is di-n-butyltin oxide, commercially available as “oxotin”. An example of a suitable material is Fascat® 4201, a di-n-butyltin oxide from Atofina.

Preferred acidic organic catalysts are acidic organic compounds having, by way of example, phosphate groups, sulfonic acid groups, sulfate groups, or phosphonic acid groups. Particular preference is given to sulfonic acids, such as para-toluenesulfonic acid. It is also possible to use acidic ion exchangers as acidic organic catalysts, an example being polystyrene resins which contain sulfonic acid groups and which have been crosslinked with about 2 mol % of divinylbenzene.

If use is made of a catalyst, its amount is usually from 1 to 5000 ppm by weight, preferably from 10 to 1000 ppm by weight, based on the entirety of carboxylic acid and amino alcohol.

Specifically, the reaction of the comonomers C can also be catalyzed via conventional amidation catalysts, if required. Examples of these catalysts are ammonium phosphate, triphenyl phosphite, and dicyclohexylcarbodiimide. In particular in the case of heat-sensitive comonomers C, and in the case of methacrylates or fatty alcohols as comonomer C, the reaction may also be catalyzed via enzymes, usually operating at from 40 to 90° C., preferably from 50 to 85° C., and in particular from 55 to 80° C., and in the presence of a free-radical inhibitor.

Free-radical polymerization and also undesired crosslinking reactions of unsaturated functional groups are inhibited by the inhibitor and, if appropriate, by operating under an inert gas. Examples of these inhibitors are hydroquinone, the monomethyl ether of hydroquinone, phenothiazine, derivatives of phenol, e.g. 2-tert-butyl-4-methylphenol, 6-tert-butyl-2,4-dimethylphenol, or N-oxyl compounds, such as N-oxyl-4-hydroxy-2,2,6,6-tetramethylpiperidine (hydroxy-TEMPO), N-oxyl-4-oxo-2,2,6,6-tetramethylpiperidine (TEMPO), in amounts of from 50 to 2000 ppm by weight, based on the entirety of carboxylic acid and amino alcohol.

The inventive process may preferably be carried out batchwise, or else continuously, for example in stirred vessels, tubular reactors, tower reactors, or other conventional reactors, which may have static or dynamic mixers, and conventional apparatus for pressure control and temperature control, and also for operations under an inert gas.

In the case of operation without solvent, the final product is generally obtained directly and, if necessary, can be purified via conventional purification operations. If concomitant use has been made of a solvent, this may be removed in the usual way from the reaction mixture after the reaction, for example via vacuum distillation.

The polyesteramides obtainable by the inventive process are likewise provided by the invention, as is the use of the polyesteramides for the production of moldings, of foils, of fibers, or of foams, and also the moldings, foils, fibers, and foams composed of the inventive polyesteramides.

The inventive process features great simplicity. It permits the preparation of hyperbranched polyesteramides in a simple one-pot reaction. There is no need for isolation or purification of precursors or protective groups for precursors. The process has economic advantages, because the monomers are commercially available and inexpensive.

The molecular architecture of the resultant polyesteramides may be adjusted via single-stage or two-stage configuration of the reaction, and tailored chemical modification of the polymer can be achieved via introduction of comonomers C.

### EXAMPLES

All of the experiments were carried out in a temperature-controllable, evacuatable three-necked round-bottomed flask with internal thermometer, with stirring, under nitrogen. The viscosity of the reaction mixture was checked visually or via sampling and testing, and the acid number was likewise checked via sampling and testing. The water produced during the reaction was removed by applying a vacuum and collected in a distillation apparatus. DEA means diethanolamine. Fascat means Fascat® 4201, a di-n-butyltin oxide from Atofina.

The following properties were determined on the resultant polymer or prepolymer and are given in the table:

Viscosity to ISO 2884, using a REL-ICI cone-and-plate viscometer from Research Equipment London, at the temperature stated in the table.

Hydroxy number to DIN 53240-2, in milligrams of potassium hydroxide per gram of polymer.

Acid number to DIN 53402-2 in milligrams of potassium hydroxide per gram of polymer.

Molecular weight:number average Mn and weight average Mw via gel permeation chromatography/size exclusion chromatography (GPC/SEC) at 40° C., using a 0.05% strength by weight solution of potassium trifluoracetate in hexafluoroisopropanol (HFIP) as eluent and HFIP gel columns (polystyrene/divinylbenzene, from Polymer Laboratories).

Calibration used narrowly distributed PMMA standards from PSS with molecular weights of from M=505 to M=2 740 000.

### Inventive Example 1: Variant b)

1) 30 g (0.285 mol) of DEA and 125 g (0.855 mol) of adipic acid were used as initial charge at 130° C., and 0.16 g of Fascat was added, and the mixture was allowed to react at 150° C. for 2 hours, the water of reaction being removed in vacuo (30 mbar). As soon as the acid number determined on specimens of the reaction mixture remained constant, the reaction was terminated by allowing the mixture to cool to 20° C. The resultant polyesteramide prepolymer was slightly yellowish and viscous.

2) Taking the acid number of the prepolymer as a basis, 140 g of the resultant prepolymer were treated by adding a 1.1-fold molar amount of DEA (99 g, 0.94 mol), and the water was removed in vacuo (from 10 to 20 mbar). As soon as the viscosity of the reaction mixture had ceased to rise further (indicating the end of the reaction) and the acid number was 15 mg KOH/g, the reaction was terminated by allowing the mixture to cool to 20° C. The resultant polyesteramide was slightly yellowish and viscous.

### Inventive Example 2: Variant a)

719 g (6.84 mol) of DEA and 1200 g (8.21 mol) of adipic acid were used as initial charge at 110° C., and 1.91 g of Fascat were added, and the mixture was allowed to react at 115° C. for 2.5 hours, the water of reaction being removed in vacuo (100 mbar). Initially, the viscosity of the reaction mixture rose slowly and uniformly. As soon as it rose sharply (i.e. prior to reaching the gel point), the reaction was terminated by allowing the mixture to cool to 20° C. The resultant polyesteramide was slightly yellowish and viscous.

### Inventive Example 3: Variant a)

### Modification of the Polymer with DEA

828 g (7.875 mol) of DEA and 1380 g (9.44 mol) of adipic acid were used as initial charge at 130° C., and 2.25 g of Fascat were added, and the mixture was allowed to react at 135° C. for 2 hours, the water of reaction being removed in vacuo (300 mbar). Initially, the viscosity of the reaction mixture rose slowly and uniformly. As soon as it rose sharply (i.e. prior to reaching the gel point), the acid number was determined as 170 mg KOH/g. 445 g (4.23 mol) of DEA were then added to the resultant polyesteramide. The mixture was allowed to react at 135° C. in vacuo for 3 hours; the reaction was then terminated by allowing the mixture to cool to 20° C. The resultant polyesteramide was slightly yellowish and viscous.

### Inventive Example 4: Variant a)

### Modification of the Polymer with Stearic Acid and DEA

60 g (0.57 mol) of DEA, 1.6 g (0.0057 mol) of stearic acid, and 100 g (0.684 mol) of adipic acid were used as initial charge at 130° C., and 0.16 ml of a 2% strength by weight sulfuric acid was added to the mixture, which was allowed to react at 130° C. for 2 hours, the water of reaction being removed in vacuo (50 mbar). Initially, the viscosity of the reaction mixture rose slowly and uniformly. As soon as it rose sharply (i.e. prior to reaching the gel point), the acid number was determined as 155 mg KOH/g. 47 g (0.45 mol) of DEA were then added to the resultant polyesteramide. The mixture was allowed to react at 135° C. in vacuo for 2.5 hours; the reaction was then terminated by allowing the mixture to cool to 20° C. The resultant polyesteramide was slightly yellowish and viscous.

### Inventive Example 5: Variant a)

### Modification of the Polymer with Glycerol Monostearate and DEA

60 g (0.57 mol) of DEA, 2 g (0.0057 mol) of glycerol monostearate, and 100 g (0.684 mol) of adipic acid were used as initial charge at 130° C., and 0.16 ml of a 2% strength by weight sulfuric acid was added to the mixture, which was allowed to react at 130° C. for 2 hours, the water of reaction being removed in vacuo (50 mbar). Initially, the viscosity of the reaction mixture rose slowly and uniformly. As soon as it rose sharply (i.e. prior to reaching the gel point), the acid number was determined as 174 mg KOH/g. 53 g (0.50 mol) of DEA were then added to the resultant polyesteramide. The mixture was allowed to react at 135° C. in vacuo for 5 hours; the reaction was then terminated by allowing the mixture to cool to 20° C. The resultant polyesteramide was slightly yellowish and viscous.

The table gives the results.

TABLE
Test results

| | | Acid | Hydroxy | Mol. mass | Mol. mass |
|---|---|---|---|---|---|
| Exam- | Viscosity¹⁾ | number | number | Mn | Mw |
| ple | [mPa · s] | [mg KOH/g] | [mg KOH/g] | [g/mol] | [g/mol] |
| 1 1) | 600 | 342 | 19 | 4100 | 11 500 |
| | (125° C.) | | | | |
| 1 2) | 7400 | 15 | 383 | 5700 | 21 000 |
| | (100° C.) | | | | |
| 2 | 2400 | 110 | 85 | 2600 | 9500 |
| | (100° C.) | | | | |
| 3 | 3600 | 33 | 353 | 3300 | 11 300 |
| | (100° C.) | | | | |
| 4 | 6200 | 11 | 408 | 3500 | 16 100 |
| | (100° C.) | | | | |
| 5 | 5800 | 8 | 426 | 3700 | 16 200 |
| | (100° C.) | | | | |

¹⁾Test temperature in brackets

1-11. (canceled)

12. A process comprising:
(a) providing a carboxylic acid having at least two carboxy groups, and an amino alcohol having at least one amino group and at least two hydroxy groups; and
(b) reacting the carboxylic acid and the amino alcohol in a molar ratio selected from ratio values of; (i) 1.1:1 to 1.95:1, to form a highly branched or hyperbranched polyesteramide; and (ii) 2:1 to 10:1, to form a prepolymer, and reacting the prepolymer with a monomer having at least one functional group to form a highly branched or hyperbranched polyesteramide.

13. The process according to claim 12, wherein the carboxylic acid and the amino alcohol are reacted in a molar ratio of 1.2:1 to 1.5:1 to form the highly branched or hyperbranched polyesteramide.

14. The process according to claim 12, wherein the carboxylic acid and the amino alcohol are reacted in a molar ratio of 2.9:1 to 3.5:1 to form the prepolymer, and the prepolymer is reacted with the monomer having at least one functional group to form the highly branched or hyperbranched polyesteramide.

15. The process according to claim 12, wherein the carboxylic acid comprises a dicarboxylic acid and the amino alcohol has one amino group and two hydroxy groups.

16. The process according to claim 13, wherein the carboxylic acid comprises a dicarboxylic acid and the amino alcohol has one amino group and two hydroxy groups.

17. The process according to claim 14, wherein the carboxylic acid comprises a dicarboxylic acid and the amino alcohol has one amino group and two hydroxy groups.

18. The process according to claim 12, wherein the carboxylic acid comprises adipic acid.

19. The process according to claim 13, wherein the carboxylic acid comprises adipic acid.

20. The process according to claim 14, wherein the carboxylic acid comprises adipic acid.

21. The process according to claim 12, wherein the amino alcohol comprises diethanolamine.

22. The process according to claim 13, wherein the amino alcohol comprises diethanolamine.

23. The process according to claim 14, wherein the amino alcohol comprises diethanolamine.

24. The process according to claim 12, wherein the carboxylic acid comprises adipic acid and the amino alcohol comprises diethanolamine.

25. The process according to claim 13, wherein the carboxylic acid comprises adipic acid and the amino alcohol comprises diethanolamine.

26. The process according to claim 14, wherein the carboxylic acid comprises adipic acid and the amino alcohol comprises diethanolamine.

27. The process according to claim 12, wherein the monomer comprises a compound selected from the group consisting of alcohols, amines, amino alcohols and mixtures thereof.

28. The process according to claim 12, wherein a comonomer is added to the reaction.

29. A polyesteramide prepared by the process according to claim 12.

30. An article comprising the polyesteramide according to claim 29, wherein the article is selected from the group consisting of moldings, foils, fibers, foams and combinations thereof.
